(19) United States
(12) Patent Application Publication
(10) Pub. No.: US 2004/0228465 A1
(43) Pub. Date: Nov. 18, 2004

(54) Generation of telecommunication connections in a communication network

(75) Inventor: Klaus-Peter Schwank, Martinsried (DE)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/860,068

(22) Filed: Jun. 4, 2004

Related U.S. Application Data
(63) Continuation of application No. PCT/DE02/04427, filed on Dec. 3, 2002.

(30) Foreign Application Priority Data
Oct. 12, 2001 (DE) 101 60 471.8

(51) Int. Cl. H04M 7/00

(52) U.S. Cl. 379/219; 379/220.01

(57) ABSTRACT

A method and circuit arrangement for establishing telecommunication links in a communication network between subscriber stations connected to this network and/or separate networks. In order to establish telecommunication links in a communication network (KN), in particular a public switched network, between subscriber stations which belong to different subscriber groups (A1, A2; B1, B2, B3) of at least one subscriber grouping, and/or from or to separate networks (external networks) via separate terminating devices (T1, T2, T3) individual markers supplied by the subscriber stations concerned and/or via the separate networks and/or dialing information which takes into account only the own numbering plan in each case are used in the terminating devices (T1, T2, T3).

### CROSS REFERENCE TO RELATED APPLICATIONS

The present application is a continuation of international application PCT/DE02/04427, filed Dec. 03, 2002, which designated the United States and further claims priority to German application DE10160471.8, filed Dec. 10, 2001, the both of which are herein incorporated by reference.

### BACKGROUND OF THE INVENTION

The invention relates to a method and a circuit arrangement for establishing telecommunication links in a communication network, in particular a public switched network or system, between subscriber stations which belong to different subscriber groups of at least one subscriber grouping, and/or from or to separate networks (external networks) of at least one network grouping, the subscriber groups concerned and the separate networks being connected via separate terminating equipment to the aforementioned communication network in which subscriber stations of the subscriber groups concerned and the separate networks concerned are connected via communication paths separated from normal communication paths.

In order to establish telecommunication links of the type described above, it is customary to provide so-called dedicated connections, i.e. semi-permanent connections between the individual subscriber groups of a subscriber grouping within the communication network through which the subscriber groups concerned can be connected to one another. Analogous rules apply where, instead of subscriber groups, separate networks (so-called external networks) are connected to the communication network concerned. As a result, while such connections exist independent of the load on the remaining part of the communication network, this does, however, mean that resources on the control side in the communication network concerned are in every case constantly tied up in supervising the links of the semipermanent connections concerned. This is occasionally seen as disadvantageous viewpoint of making efficient use of controllers of the communication network concerned.

While it is also possible to establish in the communication network concerned telecommunication links between subscriber stations which belong to different subscriber groups of at least one subscriber grouping whose subscriber groups are connected via separate terminating equipment to a communication network, in particular a public switching system, in the same way as telecommunication links of normal subscriber stations which are connected to the telecommunication network concerned, this means, however, that the numbering plan of the communication network concerned must be taken into consideration from each calling subscriber station, including those of the subscriber groups of the subscriber grouping concerned. If, for example, two subscriber groups of a subscriber grouping are connected to a communication network like the public switched network at stations located far apart from one another such as e.g. in Hamburg and in Munich, this means that the subscriber stations of the aforementioned two subscriber groups must in the course of establishing a connection supply the relevant dialing information for long-distance dialing in the communication network concerned. In this case, too, analogous rules apply if, instead of subscriber groups, separate networks (so-called external networks) are connected to the communication network concerned. Consequently, however, establishment of the respective connection entails an unwanted additional outlay for the subscriber stations of the respective subscriber group.

### SUMMARY OF THE INVENTION

The object of the invention is therefore to indicate a way in which telecommunication links can be established in a relatively simple manner between subscriber stations which belong to different subscriber groups of at least one subscriber grouping whose subscriber groups are connected via separate terminating equipment to a communication network, in particular a public switched network or switching system, and/or from or to separate networks (external networks) connected to the communication network concerned via separate terminating devices, without constantly having to use resources of controllers of the communication network concerned for this purpose and also without having to take into consideration the numbering plan of the communication network concerned in the case of the subscriber stations of the subscriber groups specified and in the separate networks.

The object indicated above is achieved according to the invention by a method of the type specified in the introduction, in that telecommunication links are established from the separate terminating equipment in the aforementioned communication network between subscriber stations which belong to the subscriber groups connected with the aforementioned terminating equipment, and/or from or to the aforementioned separate networks solely according to markers individually identifying the subscriber groups concerned and/or the aforementioned separate networks.

The invention is distinguished by the advantage that telecommunication links can be established in the aforementioned communication network in a particularly simple way between subscriber stations which belong to different subscriber groups of at least one subscriber grouping whose subscriber groups are connected via separate terminating equipment to the communication network and/or from or to separate networks which are connected to the communication network via separate terminating equipment, in that only the individual markers for the subscriber groups concerned and consequently for the subscriber grouping comprising these subscriber groups or the markers for the respective separate networks have to be taken to account, without this otherwise entailing an excessive strain on resources, such as on controllers of the communication network concerned, in respect of supervising links. Here, the numbering plan of the communication network concerned does not itself play a role in establishing the aforementioned communication links either on the part of the subscriber stations of the individual subscriber groups or on the part of the separate network concerned. The aforementioned individual markers may, for example, in each case when corresponding call requests originating from the aforementioned subscriber groups or separate networks occur, be identified in the aforementioned terminating equipment, or they can be provided by this terminating equipment based on the identification of call requests from the subscriber groups or separate networks concerned. In other respects, security aspects can be taken into account in a relatively simple way when establishing the telecommunication links concerned, namely by reserving specified connection paths which are available for establishing the telecommunication links concerned.

Usefully, outgoing call requests from the respective subscriber group and/or the respective separate network to another subscriber group of the same subscriber grouping and/or to another separate network of the respective network grouping are identified in the terminating equipment in each case by means of a group or grouping code also supplied in the course of establishment of the respective connection. This brings with it the advantage of a low outlay in terms of identification for establishing the aforementioned telecommunication links.

Dialing information supplied in the respective terminating equipment of subscriber stations of the aforementioned subscriber groups and/or of the separate networks, said dialing information relating to the communication link to be established in each case, is preferably considered in accordance solely with the numbering plan of the subscriber grouping comprising the respective subscriber groups and/or in accordance solely with the numbering plan of the network grouping comprising the respective separate networks. This yields the advantage that in a particularly simple way only the numbering plan associated with the subscriber groups of the respective subscriber grouping or that associated with the separate networks of the respective network grouping needs to be considered by the individual subscriber groups or separate networks in order to establish requested links between the subscriber stations of these subscriber groups or the aforementioned separate networks.

A circuit arrangement in which subscriber groups of at least one subscriber grouping, each subscriber group comprising a number of subscriber stations and/or separate networks (external networks) of at least one network grouping are connected by means of separate terminating devices to a communication network, in particular a public switching system, will preferably be used to implement the method according to the invention. This circuit arrangement is characterized according to the present invention in that in the respective terminating equipment there are provided marker or dialing information recognition and connection control devices which, using the marker and/or dialing information supplied by subscriber stations of the subscriber groups concerned and/or via the respective separate network relating to at least one subscriber station of another subscriber group of the same subscriber grouping or a further separate network of the network grouping concerned connected to the communication network concerned, indicate in each case one connection path, defined solely thereby, within the aforementioned communication network for the communication link to be established in each case, which path can be set up in the aforementioned communication network. This brings with it the advantage of a particularly low circuit-engineering outlay on implementing the method according to the invention.

The marker or dialing information recognition and connection control devices preferably have memory tables in which control information indicating defined connection paths in the aforementioned communication network is stored, which control information can be activated to recognize in each case specified markers or dialing information. By this means, telecommunication links can in an advantageous way be established between a large number of subscriber groups of a subscriber grouping or from/to separate networks in the aforementioned communication network without the communication network's controllers constantly being burdened in an unwanted way with supervision of the links.

### BRIEF DESCRIPTION OF THE SEVERAL VIEWS OF THE DRAWINGS

The invention is described in detail below with reference in a drawing to an exemplary embodiment of a circuit arrangement for implementing the method according to the invention.

### DETAILED DESCRIPTION OF THE INVENTION

The drawing indicates broadly a communication network KN which may in particular be a public switched network or switching system, as for example is in operation as a digital electronic switching system (EWSD). The communication network KN concerned may for example be a country-wide communication system. The communication network KN may include multiple exchanges which have their own controllers and which are connected to one another.

In the present embodiment, subscriber groups, each comprising a number of subscriber stations (not shown), of two subscriber groupings and/or separate networks (external networks) are connected to the communication network KN, and can be operated as separate switched subscriber networks or as transit communication networks. The separate networks concerned may be private branch networks or else separate public communication networks which, for example, are operated by a different operator than the aforementioned communication network KN. Where subscriber groupings and subscriber groups are referred to below, these also include the separate networks concerned. A separate network thus corresponds to a subscriber group, and a series of organizationally or otherwise related separate networks forms a network grouping corresponding to a subscriber grouping. It should also be noted at this point that a separate network or even a network grouping can also on principle belong to a subscriber grouping, for example in the case where the subscriber groups of the subscriber grouping concerned are connected to communication networks provided geographically very far apart, so that it is necessary to establish intercontinental links between the subscriber groups of the subscriber grouping concerned.

The one subscriber grouping, described below as the second subscriber grouping, includes the subscriber groups A1 and A2; the other subscriber grouping, described below as the first subscriber grouping, includes the subscriber groups B1, B2 and B3. On principle, any number of subscriber groupings may be provided, each comprising at least two subscriber groups of subscriber stations. A subscriber grouping may for example comprise subscriber groups with subscriber stations of a company or of a group of companies. The subscriber groups concerned may in this case be connected to the communication network KN at places located geographically far apart, for example in Hamburg and in Munich, as has been mentioned in the introduction.

The individual subscriber groups A1 and A2 and B1, B2 and B3 are connected to the communication network KN via separate terminating devices T1, T2 and T3. In the present case, the subscriber groups A1 and B1 are connected jointly via access lines LA1 and LB2 to the terminating device T1 and via this to the communication network KN. In an analogous way, the subscriber groups A2 and B2 are connected by means of access lines LA2 and B2 to the terminating device T2 and via this to the communication network KN. The subscriber group B3 is connected by means of access lines LB3 to the terminating device T3 and via this to the communication network KN.

The terminating devices T1, T2 and T3 each have a marker or dialing information recognition device D1, D2 or D3 and a connection control device R1, R2 or R3. The functions of these devices are described in detail further below. The connection control devices R1, R2 and R3 can in the present case be connected to one another within the communication network KN via only two connection paths C13 and C23, which the dashed marking of these connection paths is intended to illustrate. Originally, the connection control devices R1, R2 and R3 are not permanently connected to one another, as is the case, on the other hand, with the semi-permanent connections mentioned in the introduction. Meanwhile, the connection paths concerned C13 and C23 are, as will be seen below, not established or through-connected until there is appropriate demand between subscriber stations of different subscriber groups of a subscriber grouping. On principle, further connection paths corresponding to the connection paths mentioned can, if there is appropriate demand (determined, for example, by the traffic load in each case), be provided in the communication network KN. Administration in the communication network KN can be affected such that all connection paths which are to be used as separate connection paths for telecommunication links between subscriber groups of the aforementioned subscriber groupings, are reserved for such connections, and are therefore not available for other connections within the communication network KN, that is, for those which cannot be used in the communication network as normal connection paths. In the marker or dialing information recognition and connection control devices, there are usefully provided memory tables in which routing or control information indicating certain fixed connection paths in the communication network KN is stored, which information can be activated to recognize in each case defined markers and/or dialing information in order then to establish or through-connect the connection paths concerned.

The method according to the invention, according to which the circuit arrangement described functions or is operated, is described in detail below.

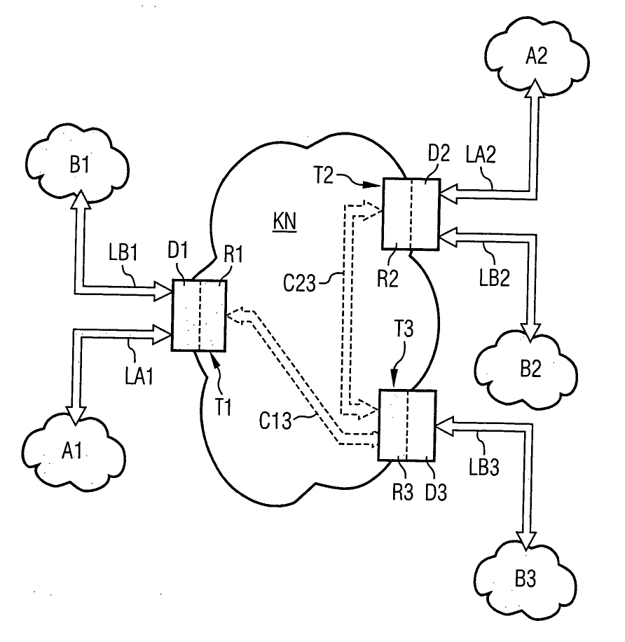

If in the circuit configuration which can be seen in FIG. 1 telecommunication links are to be established between subscriber stations of the two subscriber groups B1 and B3 belonging to the first subscriber grouping, then it suffices for the marker or dialing information recognition devices D1 or D3 of the two terminating devices T1 and T3, said recognition devices being connected to the subscriber group concerned B1 or B3 and being responsible here for establishment of a connection in the communication network KN, to recognize by means of a group identifier or grouping identifier, i.e. a marker, also supplied in the course of establishment of the respective connection, that this is a call request to the other subscriber group of the first subscriber grouping concerned. It suffices in this case to activate a routing or connection control information in the associated marker or dialing information recognition and connection control device D1, R1 or D3, R3 of the terminating device T1 or T3 in order to set up the telecommunication link desired in each case in the specified communication network KN to the other subscriber group B3 or B1 on the connection path C13. The connection control devices R1 and R3 of the marker or dialing information recognition and connection control devices D1, R1 or D3, R3 establish here the desired telecommunication link within the communication network KN between the two subscriber groups B1 and B3 belonging to the first subscriber grouping or arrange for this link to be established, without the subscriber stations of the line/trunk groups concerned B1, B3 having to contribute anything other than the aforementioned marker. The numbering plan of the communication network KN itself plays no role for the subscriber stations concerned with regard to supply of the aforementioned marker; the numbering plan concerned of the communication network KN is critical only for the connection control devices R1, R3 of the terminating devices mentioned T1, T3 and is also taken into account there.

Conditions which match fully the conditions just described also apply when connections are to be established between subscriber stations of the two subscriber groups B2 and B3 belonging to the first subscriber grouping concerned. In this case, a connection is established within the communication network KN via the direct connection path C23 indicated in the drawing between subscriber stations of the two subscriber groups B2 and B3 belonging to the first subscriber grouping.

The case should now be considered where telecommunication links are to be established between subscriber stations of subscriber groups B1 and B2 of the first subscriber grouping indicated in the drawing. In this case, the marker or group identifier identified in the respective dialing information recognition device D1, D2 or D3 will not suffice in order to establish the particular telecommunication link desired in the communication network KN since in the present case no direct communication connection path is stipulated between the two subscriber groups B1 and B2 of the first subscriber grouping concerned. According to the invention, the group identifier concerned is therefore replaced or supplemented with the dialing information which designates the desired subscriber station in each case to be called in the appropriate subscriber group of the subscriber grouping concerned. For this reason, the marker or dialing information recognition and connection control device D1, R1 as well as D2, R2 and D3, R3 contain in their aforementioned memory tables control information indicating defined connection paths in the communication network KN, which can be activated to recognize in each case defined dialing information and which lead to the establishment of the telecommunication link required in each case in the communication network KN. The dialing information just mentioned is not changed in the communication network KN but forwarded unchanged.

If the dialing information concerned of subscriber stations of the subscriber group B1 has, for example, a “2” as a prefix, then a telecommunication link between the connection control device R1 will first be established via the connection path C13 to the connection-control device R3 as the only available connection control device for the subscriber group B1 in the present case, and from this connection control device R3 the telecommunication link will then be established via the connection path C23 to the connection control device R2. In this case, too, the subscriber stations of the individual subscriber groups B1 and B2 which belong to the aforementioned first subscriber grouping do not need to supply any dialing information concerning the numbering plan of the communication network KN in order nevertheless to be connected by the communication network KN; it suffices if the numbering plan of the subscriber grouping to which the subscriber groups, between which a telecommunication link is in each case to be established, belong, is included in the dialing information supplied in each case.

Conditions matching fully the conditions last described also otherwise apply when telecommunication links are to be established between subscriber stations of the two subscriber groups A1 and A2 belonging to the second subscriber grouping concerned. In this case, a connection is established quite analogously via the connection paths C13 and C23 indicated in the drawing within the communication network KN between the two subscriber groups A1 and A2 belonging to the second subscriber grouping.

The procedures described above with regard to the establishing of communication links between subscriber stations which belong in each case to subscriber groups of one subscriber grouping can be adapted relatively flexibly to changed conditions of affiliation, if for example the subscriber stations of a subscriber group of a subscriber grouping switch to a different subscriber grouping. In this case, only appropriate adjustments in the aforementioned marker or dialing information recognition and connection control devices have to be made.

Finally it should be noted that in the drawing, for the sake of simplicity, the subscriber groups belonging to different subscriber groupings such as the subscriber groups A1, B1 and A2, B2 are connected via a common terminating device T1 or T2 to the communication network KN. Of course, the individual subscriber groups may also be connected to the communication network KN via separate terminating devices, as for example in the case of the EWSD switching system mentioned in the introduction to PA-designated (primary rate access) or ISUP-designated (integrated services digital network user part) terminating devices. In this context, it should once again be emphasized that the subscriber group concerned may also, as has been mentioned above, be a separate network (external network).

I claim:

1. A method for establishing telecommunication links in a communication network in particular a public switched network or system, between subscriber stations which belong to different subscriber groups of at least one subscriber grouping, and/or from or to separate networks (external networks) of at least one network grouping, the subscriber groups concerned and the separate networks being connected via separate terminating equipment to the aforementioned communication network in which subscriber stations of the subscriber groups concerned and the separate networks concerned are connected via communication path separated from normal communication paths,
characterized in that telecommunication links are established from the separate terminating devices (T1, T2, T3) in the aforementioned communication network (KN) between subscriber stations which belong to the subscriber groups (A1, A2; B1, B2, B3) connected to the aforementioned terminating devices (T1, T2, T3), and/or from or to the aforementioned separate networks solely in accordance with markers individually identifying the subscriber groups concerned (A1, A2; B1, B2, B3) and/or the aforementioned separate networks.

2. The method according to claim 1, characterized in that outgoing call requests from the respective subscriber group (A1, A2; B1, B2, B3) and/or the respective separate network to another subscriber group of the same subscriber grouping and/or to another separate network of the respective network grouping are recognized in the terminating devices (T1, T2, T3) in each case by means of a group or grouping code also supplied in the course of establishing the respective call.

3. The method according to claim 1, characterized in that dialing information concerning the communication link to be established in each case and supplied to the respective terminating device (T1, T2, T3) from subscriber stations of the aforementioned subscriber groups (B1, B2, B3) and/or from the separate networks is considered in accordance solely with the numbering plan of the subscriber grouping comprising the subscriber groups concerned (B1, B2, B3) and/or in accordance solely with the numbering plan of the network grouping comprising the respective separate networks.

4. A circuit arrangement wherein subscriber groups (A1, A2; B1, B2, B3), each comprising a number of subscriber stations, of at least one subscriber grouping and/or separate networks (external networks) of at least one network grouping are connected by means of separate terminating devices (T1, T2, T3) to a communication network (KN), in particular a public switched network or system, characterized in that in the terminating devices concerned (T1, T2, T3) marker or dialing information recognition and connection control devices (D1, D2, D3; R1, R2, R3) are provided which, using the marker and/or dialing information supplied by subscriber stations of the subscriber groups concerned (A1, A2; B1, B2, B3) and/or via the respective separate network relating to at least one subscriber station of another subscriber group of the same subscriber grouping or to an additional separate network of the respective network grouping connected to the communication network concerned (KN), each designate a connection path, defined solely thereby, within the aforementioned communication network (KN) for the communication link to be established in each case and which can be set up in the aforementioned communication network.

5. A circuit arrangement according to claim 4 characterized in that the marker or dialing information recognition and connection control devices (D1, D2, D3; R1, R2, R3) have memory tables in which control information indicating defined connection paths (C12, C23) in the aforementioned communication network (KN) is stored, which control information can be activated to recognize in each case defined markers or dialing information.
